(19) United States
(12) Patent Application Publication
(10) Pub. No.: US 2025/0341284 A1
(43) Pub. Date: Nov. 6, 2025

(54) Shallow Water LNG Processing Barge

(71) Applicants: Annika Hvide, Piedmont, CA (US); Erik He, Singapore (SG); He Yi Yong, Singapore (SG); Hans Hvide, Singapore (SG)

(72) Inventors: Annika Hvide, Piedmont, CA (US); Erik He, Singapore (SG); He Yi Yong, Singapore (SG); Hans Hvide, Singapore (SG)

(21) Appl. No.: 18/831,025

(22) Filed: May 1, 2024

(51) Int. Cl. F17C 5/02; B63B 27/25; B63B 35/28; B63B 35/34; B63B 35/44

(52) U.S. Cl. CPC F17C 5/02; B63B 27/25; B63B 35/28; B63B 35/34; B63B 35/44; B63B 2035/448; B63B 2035/4486; F17C 2201/0185; F17C 2201/052; F17C 2221/033; F17C 2223/0153; F17C 2265/06; F17C 2270/0113

(57) ABSTRACT

A floating LNG storage barge with one or more LNG tanks provides mobile storage for LNG, by obtaining LNG from one or more LNG ocean transport vessels while the LNG storage barge is moored to a land-based jetty, transferring LNG to one or more land transfer trucks, pipelines or railroad tankers using an LNG distribution manifold and flexible hoses between the distribution manifold and the trucks via pumps or pressure differential between the LNG storage barge with the potential for LNG processing adaptive capacity.

### CROSS REFERENCE TO RELATED APPLICATIONS

None.

### I. BACKGROUND OF THE INVENTION

### 1. Field of Invention

A floating LNG storage barge with one or more LNG tanks provides mobile storage for LNG, by onloading LNG from one or more LNG transport vessels while the LNG barge is moored to a land based jetty and transferring LNG to one or more land transfer trucks using an LNG distribution manifold and flexible hoses between the distribution manifold and the trucks via pumps or pressure differential between the LNG storage barge, the LNG storage barge further having LNG processing adaptive capacity.

### 2. Description of Prior Art

A preliminary review of prior art patents was conducted by the applicant which reveal prior art patents in a similar field or having similar use. However, the prior art inventions do not disclose the same or similar elements as the present LNG storage barge, nor do they present the material components in a manner contemplated or anticipated in the prior art and/or similar results using the same disclosed components.

Prior art discloses barges associated with LNG production and storage. An offshore barge for liquified gas was disclosed in U.S. Pat. No. 3,766,583 to Phelps, which used a floating concrete barge which provided a cryogenic storage tank for LNG, a liquification and gasification for stored natural gas, the concrete barge containing ballast compartments which are filled with water to sink the barge to the ocean floor where the contained gas remains stored. An ocean vessel storing multiple stacked and stored gas interface modules within an elongated cargo cavity between elevated side hulls is disclosed in U.S. Pat. No. 10,919,757 to Mermiris. It is self-propelled, designated as a “gas supply marine vessel” and is designed to provide a concave side to facilitate mooring to an adjacent shoreline, the concave side further defining angled extensions at corners of the deck with a linkspan extending from each angled extension. Mermiris further provides a gantry movable along the length of the cavity to move stored fuel container assemblies (tanks). U.S. Patent Application Publication No. 2010/00509925 A1 to Donnely, is a barge using a solid or semi-solid material to enclose natural gas storage vessels in the hold of the vessel, these storage vessel appearing to comprise a plurality of horizontal cavities with a very low center of gravity within the barge.

Other water based gas storage vessels includes a floating LNG station, comprising a floating structure, an LNG tank positioned upon the floating structure and an LNG line extending from an LNG pump to forcibly discharge the LNG from the LNG station to a water bound transport vessel in U.S. Patent Application Publication NO. 2012/0317996 to Lee.

Tugboat compelled LNG transport barges include three U.S. Patent Application publication Nos. 2012/0324910 to Shete, 2014/0319906 to Grimm, III, and 2017/0240251 to Wait, Jr. All three are LNG related ocean vessel barges that are not self-compelled but adapted to tugboat engagement through either a tow rope or an articulated tug and barge arraignment, giving the tug complete mobile operation including movement and direction. Shete provides an articulated tug and barge arrangement with the tug inserting nose-first into a rear adapted cutout portion of the barge for storage a reliquification of LNG aboard the barge unit in a type C tank with a regassification unit also coupled to the type C tank. The barge is intended to load LNG directly from a liquification plant then moved by the tug for storing LNG at a destined off-board facility. Grimm shows a very closely related arraignment between tug and barge, the barge used to carry liquified natural gas and includes an LNG electrical generator at least one other cargo, with a umbilical line providing power from the tug to the barge. Wait, JR. uses a tug to move multiple vaporizer skids containing LNG gasification and storage containers.

None of these prior art patent disclose, alone or in combination, the elements, devices or sea to land capabilities as disclosed in the present LNG vessel to barge to land truck operational features as the present shallow water LNG transfer barge.

### II. Summary of the Invention

Liquid natural gas (LNG) is primarily delivered to customers using pipelines, rail tanks or commercial trucks for land transfer. International delivery is through pipelines or large tanker vessels (135,000 m³-265,000m³) to large import terminals. At these terminals, the LNG is regassed (heated to form a gas) and exported for land transfer through methods disclosed. Building an LNG receiving terminal is both expensive and time consuming.

Recently, the United States Executive branch, for no particular reason and without legislative participation, has banned new construction of LNG terminals in port cities and denied further expansions on executive order which is now part of legal actions, which is also costly and not contusive to efficient delivery of LNG here and abroad. With political influences, the permitting process for building these terminals, if not halted completely, is proving more difficult and time consuming with mounting red tape. Local and foreign industries still have the capacity to change their fueling needs from diesel and LPG to LNG saving money on fuel costs, yet unable to do so because they are not connected to the pipeline grid. In many developing countries, there is need for replacement because LNG is cheaper, more efficient and more environmentally friendly than diesel and LPG. These countries lack LNG import terminals but would value the LNG fuel for their energy structure.

The proposed innovation consists of a floating barge with an LNG tank that provides the storage of the LNG. This tank can export the LNG to trucks using an LNG distribution manifold and flexible hoses that connect between the manifold and the trucks. The LNG may be pumped using pumps or it may be moved using a pressure differential between the LNG barge and the trucks. The LNG distribution manifold and hoses may be insulated to reduce the boil-off gas from the operation. When one LNG container is full, another comes in a replaces the one that has already been filled. This way the pumps on the LNG storage barge can run continuously without having to shut down. The vapor return line for all the containers is operating at the same pressure so that the back pressure is similar for all the containers.

When the LNG barge is full another LNG carrier comes to the outside of the LNG barge and refills the LNG barge by way of a ship-to-ship transfer operation. Alternatively, the LNG barge can leave its current location and be towed to another location where the barge can carry out a ship-to-ship LNG transfer. The preferred method is for another LNG carrier to fill up the LNG barge at the location where it discharges LNG to the trucks. The barge can be powered from shore or it can have its power plant onboard.

### III. Description of the Drawings

The following drawings are submitted with this utility patent application.

FIG. 1 is an upper front perspective view of the LNG barge.

FIG. 2 is a side cross-section view of the LNG barge.

FIG. 3 in a longitudinal cross-sectional view of the LNG barge.

FIG. 4 is a view of the LNG tanks being installed within the contoured deck on the LNG barge hull, with a first LNG tank installed and a second LNG tank being installed within the deck or subsequent to removal from the deck hold.

FIG. 5 is an upper perspective view of the LNG barge moored to a land-based jetty for off-loading or on-loading LNG from one or more semi-tractor trucks for land transport and also having an LNG transport vessel moored to the LNG barge for on-loading or off-loading LNG for ocean transport.

FIG. 6 is a diagram of the LNG barge spread moored using drag-anchors and chains to receive electrical power from a sub-sea power cable and also to transfer LNG to or from a land jetty to the LNG barge using a sub-sea pipeline with an LNG transport vessel further moored to the LNG barge for transfer of LNG from barge to vessel or vessel to barge.

### IV. Description of the Preferred Embodiment

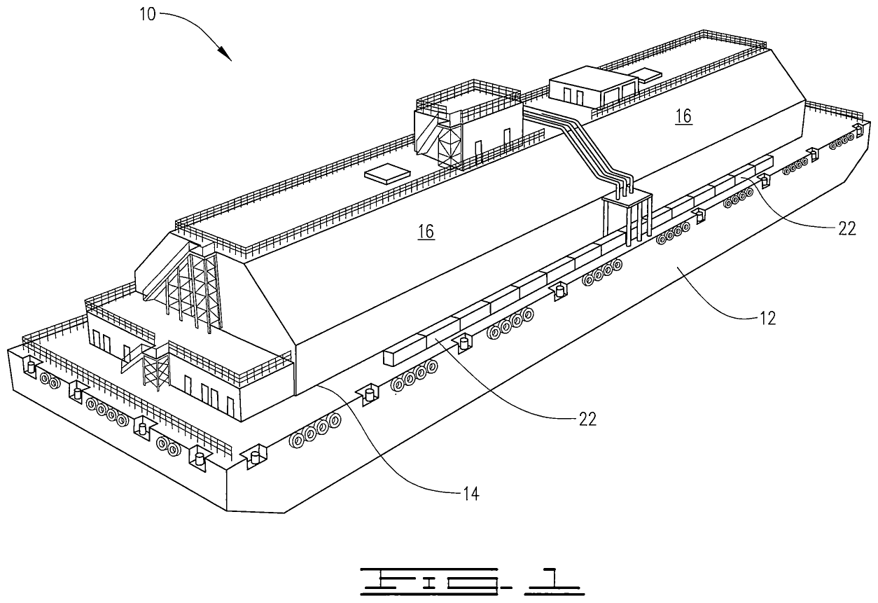

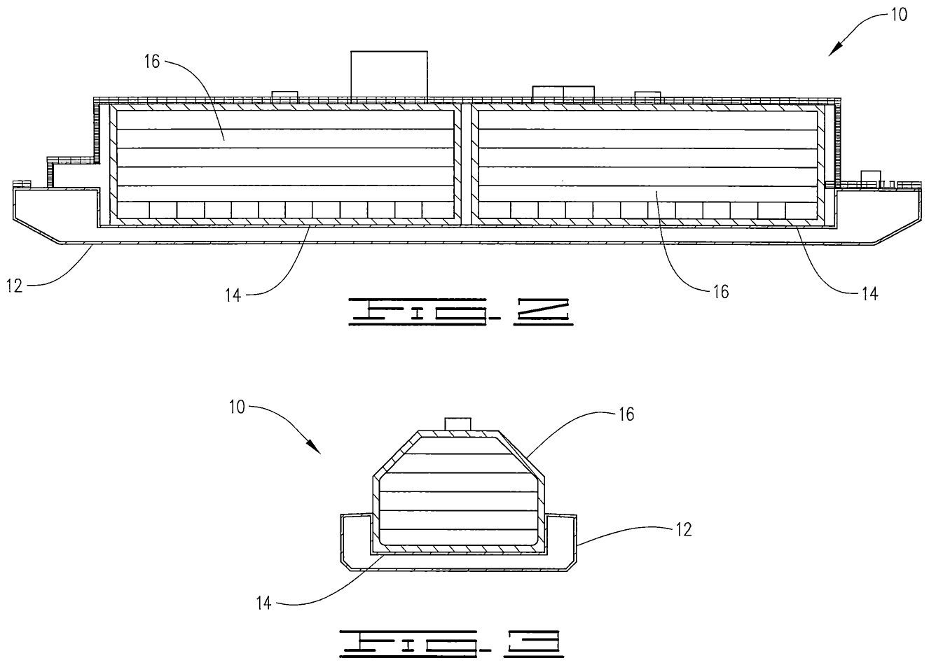

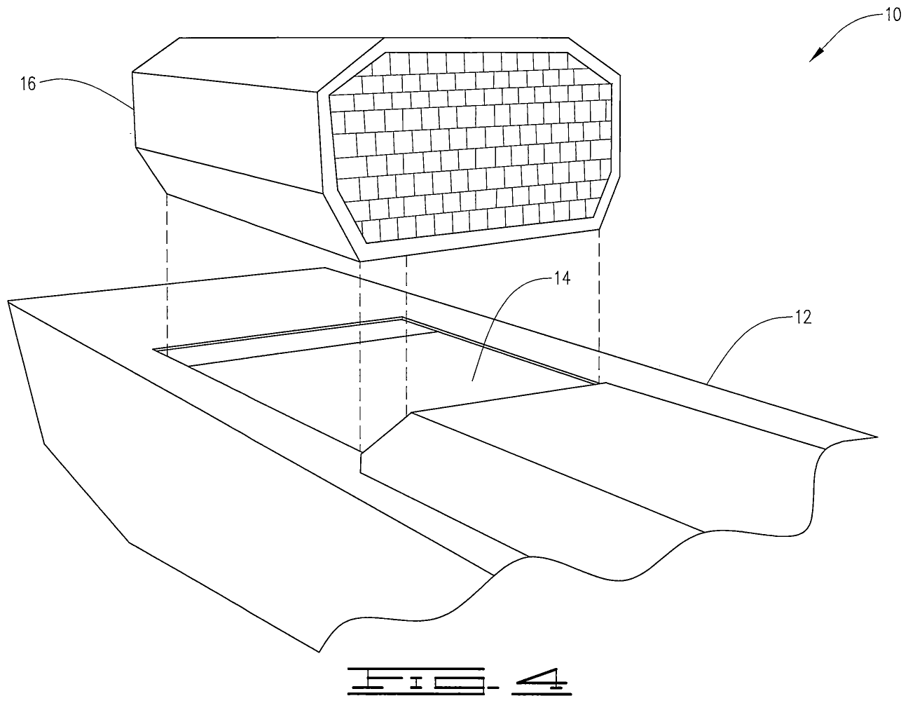

A mobile filling pontoon (MFP) with bulk LNG (liquid natural gas) storage is a floating MFP/LNG supply barge 10 used as a floating jetty moored to a land jetty J or anchored off shore serving as a transfer medium and working platform for LNG terminal operators, as shown in FIGS. 1-6. The MFP/LNG supply barge 10 (MFP) will be used to define the invention throughout the specification. Utilizing one or more replaceable LNG containment modules 16 conformed and adapted to be secured within an MFP hull 12 within a contoured deck 14, the MFP 10 is a ready and transferable source of LNG, and a receiving and dispensing terminal distributing from sea to sea, sea to land or land to sea.

The LNG containment modules 16, FIGS. 1-4, are storage tanks typically classified as either B tanks or C tanks for cryogenic purposes, to maintain the LNG at a sub-zero required temperature for a flowable liquid. The disclosed features and claimed elements of the MFP 10 provide the MFP 10 with the capability of being moored to the ocean floor using chains and anchors, a sea floor installed docking tower D, other floating vessels or to a dry dock. The MFP 10 is not provided with any propulsion means or internal power supply and in moved by either a tug or other vessel.

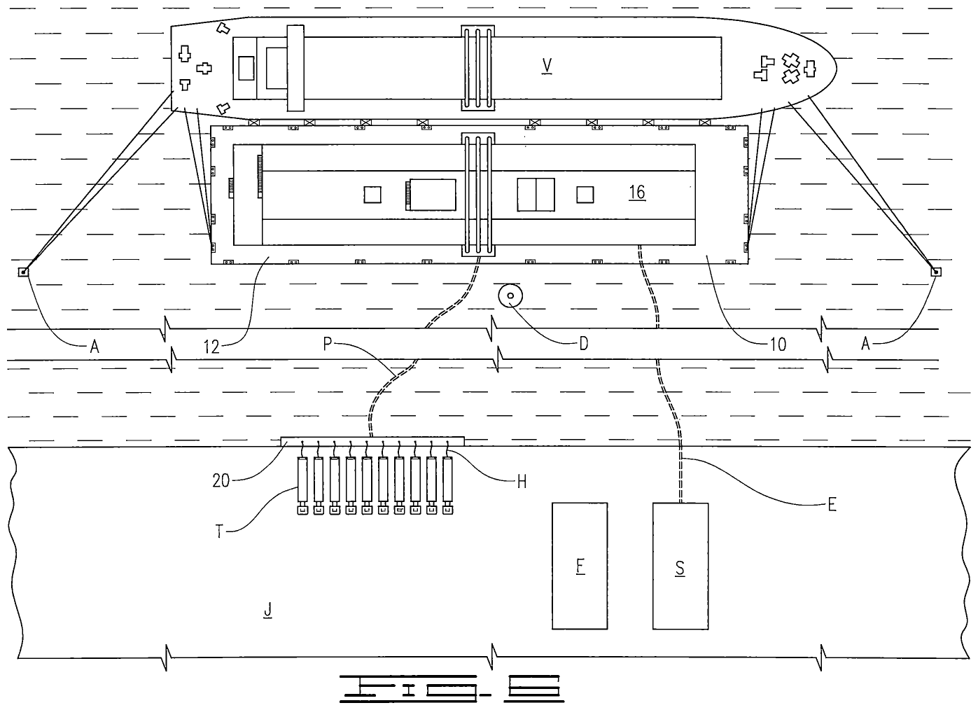

A land-based LNG distribution manifold 20 or an MFP mounted truck filling skid 22 are connected by a plurality of flexible hoses H that provide a secure connection between the LNG distribution manifold 20 and/or truck filling skids 22 and the land jetty J based trucks T to supply the LNG from the MFP 10, FIG. 5-6. For purposes of this specification, “trucks” T shall be a general term for land based vehicles, which also includes rail tanks, land pipelines and the truck tankers, all which are designed to transport LNG by land.

The MFP 10 is specifically intended to service and provide for the supply and dispensing of LNG from its LNG supply source, which may be a source terminal, another LNG ocean transport vessel V or a remote LNG processing facility, where there is limited alternate availability, where a permanent LNG distribution center is unavailable, where an LNG land based supply is not permitted or restricted by either a governmental agency, a proper license for a land based facility is disallowed at a certain location by a regulatory agency, or where it is unsafe to construct and operate an LNG supply facility on a temporary or permanent basis due to war or conflict. The MFP 10 may also have processing capabilities on-board or provided between the MFP 10 and the LNG distribution manifold 20, for gasification or liquification if so suited.

The MFP 10 being a floating storage and supply barge, is fully classified as an LNG floating storage unit (FSU). The desired storage range is between 20,000 cbm and 60,000 cbm, although possibly greater or less. It possesses truck loading capability, reliquification or regasification, with currently operating embodiments providing a length up to 200 meters, 37 meter width and a deadweight of approximately 18,130 tons. These dimensions are for reference use for illustrative purposes and are not meant to limit the dimensions of the MFP 10 or its load capacity. Two positioning options are contemplated:
a. Moored along side a land jetty J; or
b. Spread moored off shore.
   As previously indicated, the MFP 10 itself is not intended to be self-compelled and would require use of a tug for movement, allowing it to be towed from port-to-port during dangerous or unsafe weather conditions to a safe harbor or refuge. It does not have crew accommodation other than for operation as an LNG supply and requires shore power or power from another vessel for it to operate its power supply.

Advantages over other floating storage units include: 1) the MFP 10 may work as its own jetty without requiring an investment is a separate jetty, the MFP 10 being parallel moored to a shore docking station or terminal; 2) a reduced amount of capital expense and operating expense since there is not engine maintenance for propulsion or movement and very little crew cost to operate the MFP 10; 3) less than ten shore personnel in 2/3 shifts instead of a full marine crew; 4) lower consumption for a hotel load aboard the MFP 10; and 5) lower boil-off gas because the majority of the LNG content is pass-through that other FSU. One of the largest benefits is being provided with the barge portion having a shallow draft of a little as 5 meters, as opposed to other FSU requiring at least a 13 meter draft and certainly less than typical LNG transport and processing vessels which draft at a much greater depth because of keels, engines, external steering devices, or propellers, FIG. 5.

An illustration of mooring along-side a land jetty J is shown in FIG. 5, indicating the MFP 10 as used for filling up multiple trucks T simultaneously at a docking depth of less than 6 meters using a truck filling skid 22 and/or LNG distribution manifold 20 on the quay side of the MFP 10 with the MFP 10 receiving shore power from a shore based power supply S (50 Hz or 60 HZ @ 0.4 kV to 20 kV) and firewater from a shore based firewater supply F (for emergency suppression) available from shore. As can be seen from this diagram, the shore side depth is less than the sea side depth, which allows for a docking of an LNG transfer vessels V requiring a greater draft depth than the requirements for mooring to the land based dock, providing for a perpetual resupply of LNG from LNG vessels, through the stationary MFP 10 moored to the truck filling skid 22 or LNG distribution manifold 20 and its attached flexible hoses H being connected and disconnected to trucks T being sequentially loaded, or perhaps being sequentially unloaded for delivery to the LNG transport vessel to a distant destination terminal. The loading and unloading directions in the illustration are reversible, as previously disclosed.

Spread mooring, FIG. 6 is also possible, and discussed briefly and previously, as a means of using the MFP 10 for LNG supply. Spread mooring generally requires the use of drag anchors and chains to attach the MFP 10 to either a buoy, docking tower D or ocean floor anchors or piles A. In this mooring method, the LNG is transferred to shore by a trestle-supported LNG pipeline or a subsea LNG pipeline P further connecting to a shore based plurality of truck loading bays at a customer facility, FIG. 6. Cargo pumps may also be utilized suitable for the project throughput, depending on the number of trucks T serviced, not shown. The spread mooring embodiment would have the same or similar power supply and LNG transfer capability as with the land based embodiment delivered to the MFP 10 either through a flexible hose H and/or subsea electrical cables E attaching to the MFP 10.

The required and essential components of the MFP 10, FIGS. 1-3 and 5, provide a barge defining the base outer hull 12, the inner contoured deck 14 receiving at least one heavily insulated IMO Type B or Type C containment module 16 contoured to be securely fitted within the inner contoured deck 14 with restricted movement. There may be additional deck space that accepts an LNG processor, which can include regasification, reliquification or boil-off gas recovery units integrating with at least one membrane type tank or IMO Type A, B and/or Type C containment module. It is also contemplated that a version of the MFP 10 has no LNG containment module 16, but merely operates as a pass-through medium which transfers LNG through the MFP 10 from an LNG transfer vessel V through the MFP 10 which is provided with the truck filling skid 22 or LNG distribution manifold 20 for further transfer to one or more trucks T located on the land jetty J or from one LNG transfer vessel V to another.

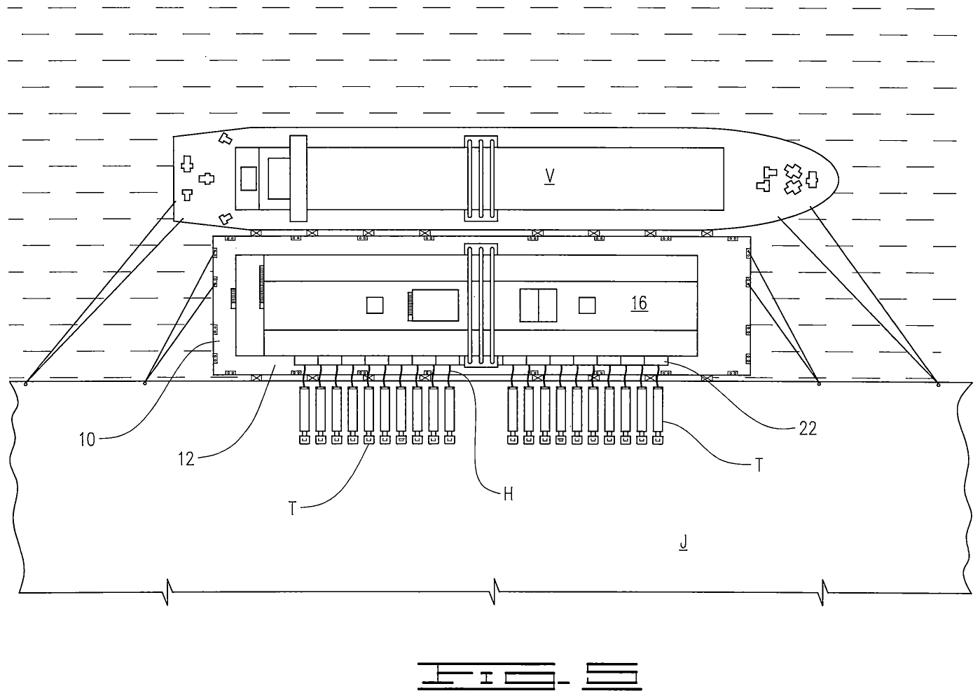

Additionally, each MFP 10 may further define the truck filling skid 22 situated on either or both sides of the barge allowing each land-operated truck T to back up to the edge of the quayside land-based jetty for hookup to the LNG supply or alternatively the LNG distribution manifold 20 on the land jetty J extending the plurality of attached flexible hoses H connecting to one or more trucks T being sequentially or simultaneously loaded, FIG. 4.

While the mobile filling pontoon and/or floating barge supply vessel (MFP) 10 has been particularly shown and described with reference to a preferred embodiment thereof, it will be understood by those skilled in the art that changes in form and detail may be made therein without departing from the spirit and scope of the invention.

I claim:

1. A floating mobile filling pontoon or liquid natural gas supply barge, providing for an ocean based supply of liquid natural gas for both land based receipt and transport supply and ocean based receipt and transport supply, the natural gas supply barge comprising:
a hull defining a contoured deck;
at least one replaceable liquid natural gas containment module adapted for secure placement within and upon said contoured deck;
a truck filling skid attached to said hull, connecting a plurality of flexible hoses to transfer or receive liquid natural gas from a plurality of land based trucks contemporaneously while said liquid natural gas supply barge is moored to a land based jetty serving as a loading platform for said land based trucks.

2. The floating mobile filling pontoon or liquid natural gas supply barge of claim 1, further comprising:
said liquid natural gas supply barge classified as an LNG floating storage unit having a storage range of 20,000 cbm and 60,000 cbm;
said hull proving a length of 200 meters more or less with a hull draft of 8.5 meters or less,; and
said at least one replaceable liquid natural gas containment module is an insulated membrane type tank or IMO Type A, Type B or Type C containment module, wherein said liquid natural gas supply barge is movable by a harbor tug or other ocean transport vessel, said liquid natural′ gas barge not equipped with any internal propulsion mechanism, reducing the number of crew members required to operate said liquid natural gas supply barge.

3. A floating mobile filling pontoon or liquid natural gas supply barge, providing for an ocean based supply of liquid natural gas for both land based receipt and transport supply and ocean based receipt and transport supply, the natural gas supply barge comprising:
a hull defining a contoured deck; and
at least one replaceable liquid natural gas containment module adapted for secure placement within and upon said contoured deck while said liquid natural gas supply barge is spread moored using drag anchors and chains and or a docking tower providing a supply of liquid natural gas through a sub-sea or floating liquid natural gas pipeline attaching to said liquid natural gas supply barge connected to an LNG distribution manifold on a land jetty, said liquid natural gas pipeline delivering and receiving liquid natural gas from one or more land based trucks contemporaneously said land jetty further providing a shore based power supply through an electrical cable attached between said land jetty and said liquid natural gas supply barge and also a firewater supply to said liquid natural gas barge in the event of a fire emergency.

4. The floating mobile filling pontoon or liquid natural gas supply barge of claim 3, further comprising:
said liquid natural gas supply barge classified as an LNG floating storage unit having a storage range of 20,000 cbm and 60,000 cbm;
said hull proving a length of 200 meters more or less with a hull draft of 8.5 meters or less,; and
said at least one replaceable liquid natural gas containment module is an insulated Membrane tank or IMO Type A, Type B or Type C containment module, wherein said liquid natural gas supply barge is movable by a harbor tug or other ocean transport vessel, said liquid natural gas barge not equipped with any internal propulsion mechanism, reducing the number of crew members required to operate said liquid natural gas supply barge.

5. The floating mobile filling pontoon or liquid natural gas supply barge of claim 3, further comprising:
an LNG distribution manifold installed upon a land jetty connecting to said liquid natural gas supply barge by an LNG pipeline, said LNG distribution manifold further connecting to a plurality of trucks by way of a respective flexible hose to transfer or receive liquid natural gas between said LNG distribution manifold and each said plurality of trucks; and
at least one flexible hose connecting said liquid natural gas supply barge to an LNG ocean transport vessel to transfer or receive a supply of liquid natural gas between said liquid natural gas supply barge and said LNG ocean transport vessel in lieu of or in addition to supplying liquid natural gas to said LNG distribution manifold while spread moored offshore.
